(19) United States
(12) Patent Application Publication
(10) Pub. No.: US 2007/0076404 A1
(43) Pub. Date: Apr. 5, 2007

(54) Dummy wire structure of light string

(76) Inventor: Yuan-Hui Tsai, Nantou (TW)

Correspondence Address: BACON & THOMAS, PLLC, 625 SLATERS LANE, FOURTH FLOOR, ALEXANDRIA, VA, 22314, US

(21) Appl. No.: 11/241,949

(22) Filed: Oct. 4, 2005

(51) Int. Cl. G03B 15/02

(52) U.S. Cl. 362/10

(57) ABSTRACT

A lamp string includes a plurality of lamps each including an insulation socket and a bulb received and fixed in the socket, an electrical wire selectively connectable to an external power source and electrically and mechanically coupled to the lamps to supply power to the lamps, and a dummy wire including a plurality of synthetic filaments entangled together as a bundle partly entangling the electrical wire. The filaments may be made of synthetic plastics, such as polyethylene, polypropylene, poly vinyl chloride, and polyamide.

### BACKGROUND OF THE INVENTION

1. Field of the Invention

The present invention relates generally to a light string for decoration in festivals, such as a Christmas light string hung around a tree or a fence, and in particular to a dummy wire that entangles and supports an electrical wire that mechanically supports and powers a plurality of lamps.

2. The Related Art

Light strings or lamp string have been widely used for decoration in celebration and festivals. A significant example is the Christmas lamp string, which comprises electrical wires to which a plurality lamp sockets are mechanically and electrically coupled. Bulbs are fit and fixed in the sockets to be powered by the electrical wires. Thus, when the electrical wires are connected to a power source, the bulbs are lit, generally in a flashing manner, to enhance the joyful atmosphere.

Dummy wires are often used in the lamp strings to help shaping or handling the lamp strings. FIGS. 1 and 1A of the attached drawings show a conventional example of the dummy wire for lamp string. As shown in FIG. 1, a conventional lamp string comprises a plurality of lamps 1A, which is comprised of an insulation socket and a bulb received and fixed in the socket. The sockets of the lamps 1A are mechanically and electrically connected to electrical wires 2A through which power from an external source, such as a wall outlet, is supplied to the bulbs. A dummy wire 3A entangles the electrical wires 2A. The dummy wire, as shown in FIG. 1A, comprises a core 31A made of cotton filaments and a plastic jacket 3A surrounding the cotton filament core 31A. Such a dual-substance structure makes recycling and handling of the dummy wire difficult, and also complicates the manufacturing of the dummy wire.

Thus, the present invention is aimed to provide a dummy wire for lamp string that eliminates the above-discussed drawbacks of the conventional dummy wires.

### SUMMARY OF THE INVENTION

An objective of the present invention is to provide a dummy wire for lamp string, which is simple in structure, easy to manufacture and handle, and low in costs.

Another objective of the present invention is to provide a dummy wire that is made of a single substance and thus facilitates recycling and environment protection.

To achieve the above objectives, in accordance with the present invention, a dummy wire is made up of a plurality of synthetic filaments fixed together as a bundle. The dummy wire is incorporated in a lamp string comprising electrical wires to which a plurality of lamps each comprising an insulation socket and a bulb received and fixed in the socket is mounted by partly and directly surrounding the electrical wire. The filaments may be made of synthetic plastics, such as polyethylene, polypropylene, poly vinyl chloride, and polyamide.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view showing a lamp string in which a conventional dummy wire entangling an electrical wire that supplies electrical power to lamps mounted to the electrical wire;

FIG. 1A is a cross-sectional view of a length of the conventional dummy wire;

FIG. 2 is an exploded view of a lamp string incorporating a dummy wire constructed in accordance with the present invention; and

FIG. 3 is an assembled view of a lamp string and the dummy wires of the present invention.

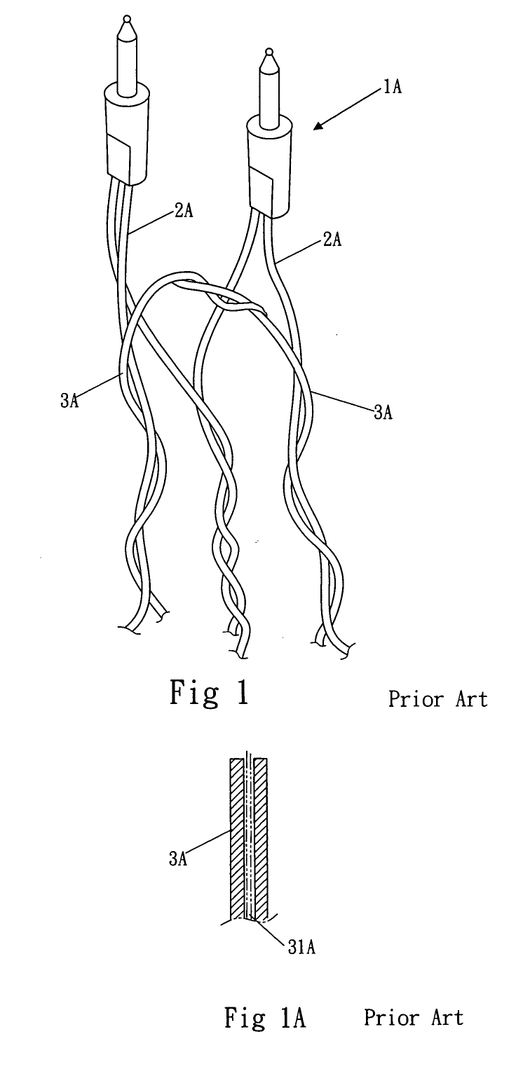

### DETAILED DESCRIPTION OF THE PREFERRED EMBODIMENT

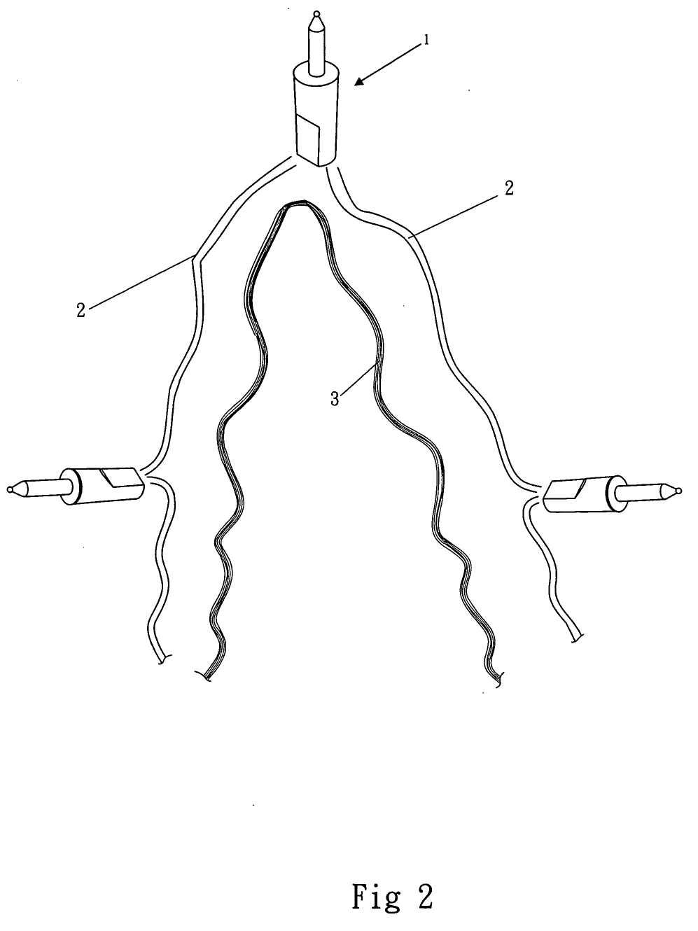

With reference to the drawings and in particular to FIG. 2, a lamp string generally comprises a plurality of lamps 1 each comprising an insulation socket and a bulb received and fixed in the socket and electrical wires to which the sockets of the lamps 1 are mounted and electrically connected to receive electrical power from an external power source (not shown).

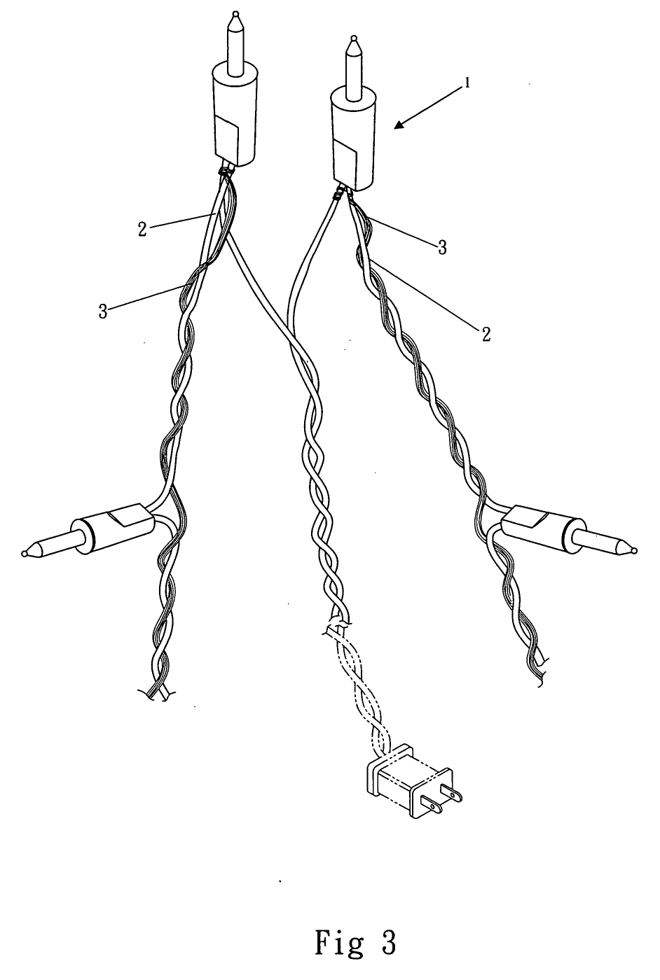

Also referring to FIG. 3, a dummy wire, generally designated with reference numeral 3, constructed in accordance with the present invention entangles at least partly the electrical wire 2 for supporting the electrical wire 2 and the lamps 1. The dummy wire 3 is comprised of a plurality of filaments made of synthetic material or plastics. The filaments are entangled together or otherwise fixed together as a bundle. The bundle of filament is then selectively, partly and directly entangled around the electrical wire 2.

Examples of the synthetic materials that make the filaments of the dummy wire 3 include polyethylene, poly vinyl chloride, polypropylene, and polyamide, but are not limited to the above listed synthetic materials. All the filaments of the dummy wire 3 are made of the same substance. This allows easy and efficient recycling of the used dummy wires.

Alternatively, the filaments of the dummy wire can be made up of different materials, and these filaments of different materials are mechanically bundled together. This, although not efficient for recycling, yet simplifying manufacturing process for there is no need to form a jacket around core filaments.

Although the present invention has been described with reference to the preferred embodiments with reference to the drawings thereof, it is apparent to those skilled in the art that a variety of modifications and changes may be made without departing from the scope of the present invention which is intended to be defined by the appended claims.

What is claimed is:

1. A lamp string comprising:
an electrical wire to which lamps are electrically mounted; and
a dummy wire comprising a plurality of filaments entangled together as a bundle partly entangling the electrical wire.

2. The lamp string as claimed in claim 1, wherein the filaments are made of the same material.

3. The lamp string as claimed in claim 2, wherein the material comprises a synthetic substance.

4. The lamp string as claimed in claim 3, wherein the synthetic substance comprises polyethylene.

5. The lamp string as claimed in claim 3, wherein the synthetic substance comprises poly vinyl chloride.

6. The lamp string as claimed in claim 3, wherein the synthetic substance comprises polypropylene.

7. The lamp string as claimed in claim 3, wherein the synthetic substance comprises polyamide.

8. The lamp string as claimed in claim 2, wherein the filaments are made of at least one synthetic substance.

9. The lamp string as claimed in claim 8, wherein the synthetic substance comprises polyethylene.

10. The lamp string as claimed in claim 8, wherein the synthetic substance comprises poly vinyl chloride.

11. The lamp string as claimed in claim 8, wherein the synthetic substance comprises polypropylene.

12. The lamp string as claimed in claim 8, wherein the synthetic substance comprises polyamide

13. A dummy wire adapted to entangle an electrical wire of a lamp string, the dummy wire comprising a bundle of synthetic filament partly and directly surrounding the electrical wire.

14. The dummy wire as claimed in claim 13, wherein the synthetic substance comprises polyethylene.

15. The dummy wire as claimed in claim 13, wherein the synthetic substance comprises poly vinyl chloride.

16. The dummy wire as claimed in claim 13, wherein the synthetic substance comprises polypropylene.

17. The dummy wire as claimed in claim 13, wherein the synthetic substance comprises polyamide.
